(19) United States
(12) Patent Application Publication
(10) Pub. No.: US 2009/0146861 A1
(43) Pub. Date: Jun. 11, 2009

(54) MULTIFUNCTIONAL REMOTE CONTROL UNIT

(76) Inventors: Guan-De LIOU, Taipei City (TW); Stephen Tsai, Taipei County (TW); Li-Li Lai, Taipei City (TW); Ming-Chun Lee, Taipei City (TW)

Correspondence Address: SINORICA, LLC, 528 FALLSGROVE DRIVE, ROCKVILLE, MD, 20850, US

(21) Appl. No.: 12/277,624

(22) Filed: Nov. 25, 2008

(30) Foreign Application Priority Data
Dec. 7, 2007 (TW) 096146847
May 23, 2008 (TW) 097119028

(51) Int. Cl. H04L 17/02

(52) U.S. Cl. 341/176

(57) ABSTRACT

A multifunctional remote control unit comprises a main body of remote control unit receiving and having a sheet of mirror equipped in the back of front shell, and front magnetic rim placed in the back peripheral, a spacer placed into make-up products of a comb and powder puff, and rear magnetic rim placed in the back peripheral, and a hinge connected with the remote control unit and spacer, by means of hinge, front magnetic rim and rear magnetic rim to absorb each other so as to form the remote control unit.

### BACKGROUND OF THE INVENTION

The present invention relates to a remote control. More particularly, the invention relates to an improvement of a remote control for a house appliance controller, which also has a magnifying glass and a mirror.

### DESCRIPTION OF PRIOR ART

The traditional remote control unit is only for controlling a main machine by using the remote control unit, such as: a television set, air conditioner, audio player, recorder, etc. Such remote control is only a function to send or receive the signal, without providing relative peripheral functions. Thus, the traditional remote control is unable to satisfy the user's needs while using the remote control. Such as: when the remote control is used to control a television set, an elder with presbyopia needs to read smaller words of foreshow of program or propaganda and he must have a magnifying glass whereby to clearly see the words. Further, when a female enjoys a sight of a TV program and needs to put on make-up, she requires and holds a mirror to enable her for put on make-ups. Therefore, while using the remote control, also several objects are required and occupied the table space. Not only the space is untidy, but also the usage is inconvenient. Even it would be annoyed and displeased without finding the required object while said objects will be used. The present invention provides several ways to overcome the said inconvenience as follows:

First objective is a multi-function remote control including: a first casing with a back shell and a transceiver component is installed in said back shell of a remote control to send and receive remote control signal; a second casing relates to the upper back shell of the first casing in a manner of open and close, connected with the side by the hinge, and a storage space is formed between the back shell and the second casing, which holding specific at least one accessory or a mirror in the storage space.

Second objective is a multi-function remote control including: a remote control body and a remote control signal transceiver component is installed in said remote control body whereby to send and receive signals; a magnifying glass is installed in the remote control body; and a mirror is installed at the storage space.

Further, a magnifying glass can be pivoted on the remote control body or the magnifying glass and the mirror can be slide out or slide in the remote control body by the guiding structure.

Third objective is a multi-function remote control including: a remote control body is installed with a screen in the front face of said remote control body; and an embedded lens is installed in the top face.

Further, the embedded lens is installed in the top face of the remote control body, by means of the guiding structure to make the embedded lens slide out and slide in the remote control body. The embedded lens is installed in the front face and back face by means of the control key to switch into magnifying glass or mirror.

Taiwanese Patent Open Publication No. 200737752, entitled “A multifunctional remote control unit”, it is only a remote control to disclose an addition of a computer in connection with broadcasting music. Such addition is only an additional function, and it is unable to satisfying the user to use the remote control for other functions.

Further, Taiwanese Patent No. 456112 entitled “A multiple used remote control display through touch and control”, it is only an improvement for the user to use the remote control machine's interface and also control other several electronic products.

### SUMMARY OF THE INVENTION

In view of the forementioned facts and the techniques, a remote control designed with user friendly design. According to the present invention, it is an object to provide a remote control used by a user to satisfy the usage to be more convenient and practical. Another object of the present invention is to provide a multiple functional remote control unit with comprehensively thinking and design.

The present invention relates to a multi-function remote control, comprising: the first casing, with a back shell, a transceiver component is installed in the first casing of a remote control to send and receive remote control signal; the second casing, in a manner of open and close, connected with the side by the hinge, and a storage space is formed between back shell and the second casing, which can store specific cosmetic accessories in the storage space.

Another embodiment of the present invention of a multi-function remote control includes: a remote control body with a back shell, a remote control signal transceiver component to be installed in said remote control body whereby to send and receive signals; a magnifying glass installed in the remote control body; and a mirror installed at the storage space.

A further embodiment of the present invention of a multi-function remote control includes: remote control body having a first slot and a second slot, in which said first slot and a second slot respectively having a first-guiding structure and a second-guiding structure; a magnifying glass to be set in the first slot, by means of the first-guiding structure; and a mirror set in the second slot, by means of the second-guiding structure.

A still further embodiment of the present invention of a multi-function remote control, including: a remote control body having a front face and one top face which having a guided positioning structure; a screen in the front face; and an embedded lens, installed at the top face and guided by the first-guiding positioning in implicit position.

Another further embodiment of the present invention of a multi-function remote control, including: a remote control body, with a front, a back and an established surface; a screen in the front; and an embedded lens installed in the established surface.

The present invention will be apparent in its novelty and features after reading the detailed description of the preferred embodiment thereof in reference to the accompanying drawings.

### BRIEF DESCRIPTION OF THE DRAWINGS

FIG. 1 is a perspective view of a multifunctional remote control unit of the present invention.

FIG. 2-1 is a perspective view of a magnifying glass in accordance with a multifunctional remote control unit of the present invention.

FIG. 2-2 is a perspective view of a magnifying glass rotate up at one side in accordance with a multifunctional remote control unit of the present invention.

FIG. 3-1 is another perspective view of a magnifying glass in accordance with a multifunctional remote control unit of the present invention.

FIG. 3-2 is a perspective view of a magnifying glass flip up in accordance with a multifunctional remote control unit of the present invention.

FIG. 4 is a perspective view of a magnifying glass and mirror sliding out for use in accordance with a multifunctional remote control unit of the present invention.

FIG. 5 is a perspective view of a magnifying glass to spring out for use in accordance with a multifunctional remote control unit of the present invention.

FIG. 6-1 is a front perspective view of a multifunctional remote control unit of the present invention.

FIG. 6-2 is a rear perspective view of a multifunctional remote control unit of the present invention.

FIG. 6-3 is a partially enlarged view of front part screen in accordance with a remote control unit of the present invention.

FIG. 7-1 is a front perspective view of another multifunctional remote control unit of the present invention.

FIG. 7-2 is a rear perspective view of another multifunctional remote control unit of the present invention.

### DETAILED DESCRIPTION OF THE INVENTION

In view of the product on the market of the design in the patents, all of them are not taken into consideration of the requirements of user, convenient to the user and the usage of a remote control in match with the environment.

### EXAMPLE 1

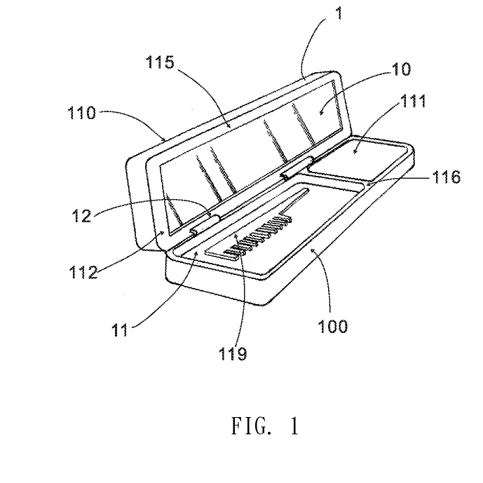

Referring to FIG. 1, the remote control body (1) is mainly composed of the first casing (110), the second casing (100) and mirror (10). The first casing (110) has the back shell (112), and the internal of which is installed with a remote control signal transceiver components (not shown in Figure) whereby to remote control signal to the specific electrical appliances (such as television), or to be set to receive a specific remote control signals. The second casing (100) are hinge (12) connected with the back shell (112) in a manner of open and close and a storage space (11) is formed between a back shell (112) and the second casing (100), which can store specific cosmetic accessories or devices. Mirror (10) can also be installed in the storage space (11), in this example, set in the back shell (112) of the first casing (110).

In addition, storage space (11) mentioned as above can hold cosmetic accessories, for example, comb (119), powder puff (111), etc. with a mirror (10). It is convenient for user to notice their appearance or complete make-up action when watching television; and products placed in the storage space (11) are not limited to as mentioned as above. Also, the first magnetic peripheral (115) can be set up on the peripheral in the back shell (112) of the first casing (110), and the corresponding second magnetic peripheral (116) can be set up on the peripheral in the second shell (100), which to make the first casing (110) and the second casing (100) close for magnetic phase magnetize each other to close tightly.

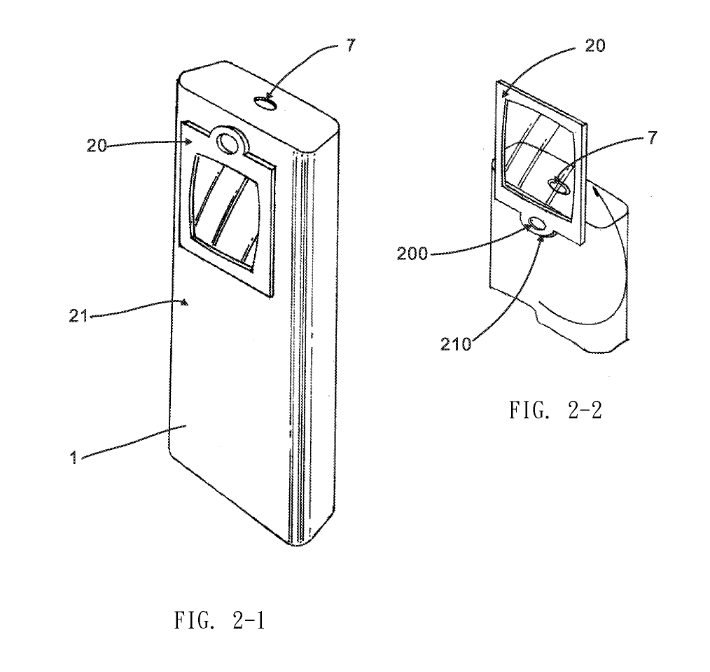

Further, the remote control body (1) in this example is also installed with an additional magnifying glass like the installation of the magnifying glass (20) as shown in the FIG. 2-1 and FIG. 2-2, set in the second casing (100), especially on the back of the second casing (100).

### EXAMPLE 2

Referring to FIG. 2-1 and FIG. 2-2, this example is mainly related with the remote control body (1) and magnifying glass (20). The remote control body (1) has a back shell (21) electroplated which function as a mirror, and the internal part of said remote control body is installed with a remote control signal transceiver components (not shown in Figure) whereby to remote control signal to the specific electrical appliances (such as television), or to be set to receive a specific remote control signals. Magnifying glass (20) is connected to the remote control body (1), and may be used in such as: rotating, or flipping way.

In this example, magnifying glass (20) are located in the top of back shell (21) of remote control body (1), the so-called “top” means near around the infrared signal receiver (7) as shown FIG. 2-2, the magnifying glass (20) can be rotate out by a pivot (200) connected to the remote control body (1), the remote control body (1) itself becomes the grip of a magnifying glass (20), The back shell (21) can be used as a mirror.

In addition, the back shell (21) mentioned as above can be made from the mirror material, or through electroplating making the back shell (21 ) like a mirror.

### EXAMPLE 3

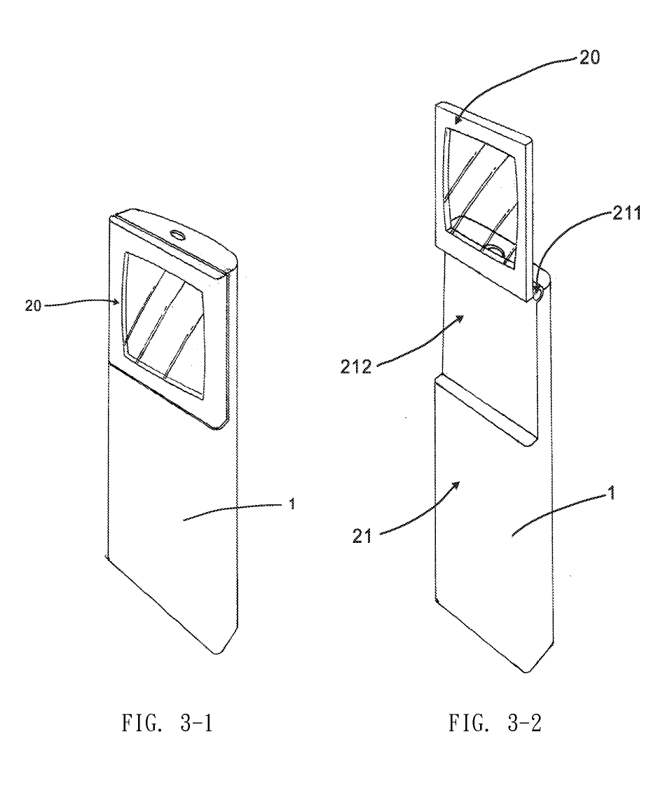

Referring to FIG. 3-1 and FIG. 3-2, the back shell (21) of the remote control body (1) in this example is located at on the top of a concave space (212) so as to store the magnifying glass(20). A rotating hinge (211) is connecting to the magnifying glass (20) and the remote control body (1), then to flip upward, that is to say, magnifying glass (20) can be rotated above upward to a remote control body (1), the remote control body (1) can be used as a grip on their own as a magnifying glass and back shell (21) can be used as a mirror.

In addition, the back shell (21) mentioned as above can be made from the mirror material, or through electroplating making the back shell (21) like a mirror.

### EXAMPLE 4

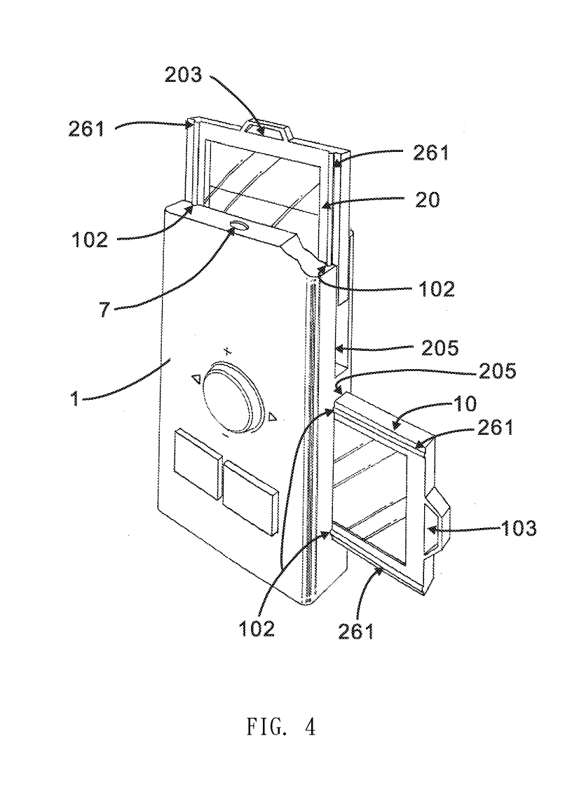

Referring to FIG. 4, this example is mainly related with the remote control body (1), magnifying glass (20) and mirror set (10). Remote control body (1) has a first slot and a second slot. The first slot and a second slot respectively have a first-guiding structure and a second-guiding structure. In this example, the first slot and second slot mentioned as above are storage space (205), and the first-guiding structure and the second-guiding structure are a guided combined structure composed of protruding tracks (261) and grooves (102). Additionally, the magnifying glass (20) is set in the first slot, and guided by the first-guiding structure in sliding locating; the mirror (10) is set in the second slot, and guided by the second-guiding structure in sliding locating.

In this example, storage space (205) is set at the top, and on the left or the right side of a remote control body (1), on whose side there are two lateral grooves (102), sliding in the storage space (205) altogether the protruding tracks (261) on two sides of the magnifying glass (20). When use the magnifying glass (20), the handle (203) position on top of the magnifying glass (20) and can the magnifying glass (20) pulled out along the protruding tracks (261) and groove (102) in a compatible direction. As the same as the magnifying glass (20), The mirror (10) set inside of remote control body (1) will be used by the mirror handle (103) to pull the mirror (10) out along the protruding tracks (261).

### EXAMPLE 5

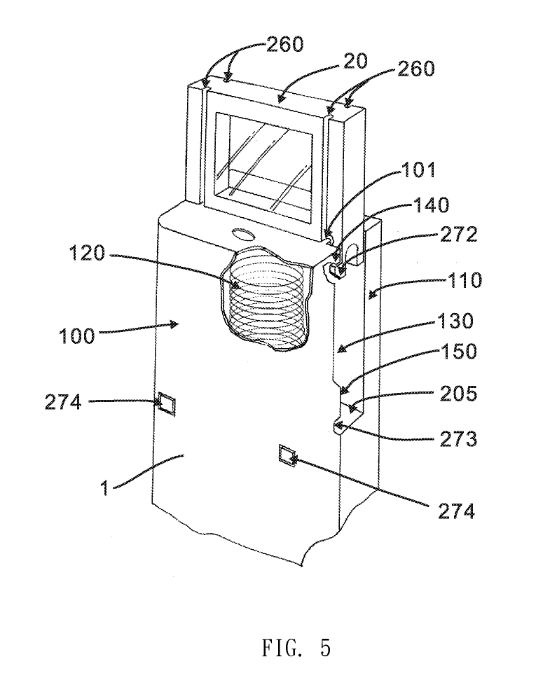

Referring to FIG. 5, a storage space (205) is located at the top of the remote control body (1). Both sides of said storage space (205) are two protruding tracks (101), which correspond to concave tracks (260) in two sides of magnifying glass (20), making the magnifying glass (20) sliding inside the storage space (205). When using the magnifying glass (20), the release key (274) on the remote control body (1) is pressed downward, the clip (272) in one side of the magnifying glass (20) deviates from the slot (273), so the spring (120) inside the remote control body (1) push the magnifying glass (20) out of remote control body (1). When the magnifying glass (20) slides upwards, the spring plate (272) pushes over the protruding member (150) into the track (130), until the clip (272) stop against the stopper (140).

Mentioned as the same as above, a mirror set (10) can be situated on one side of the remote control body (1) (no shown in figure), and like the device of the magnifying glass (20), mirror (10) can be spring out of remote control body (1).

### EXAMPLE 6

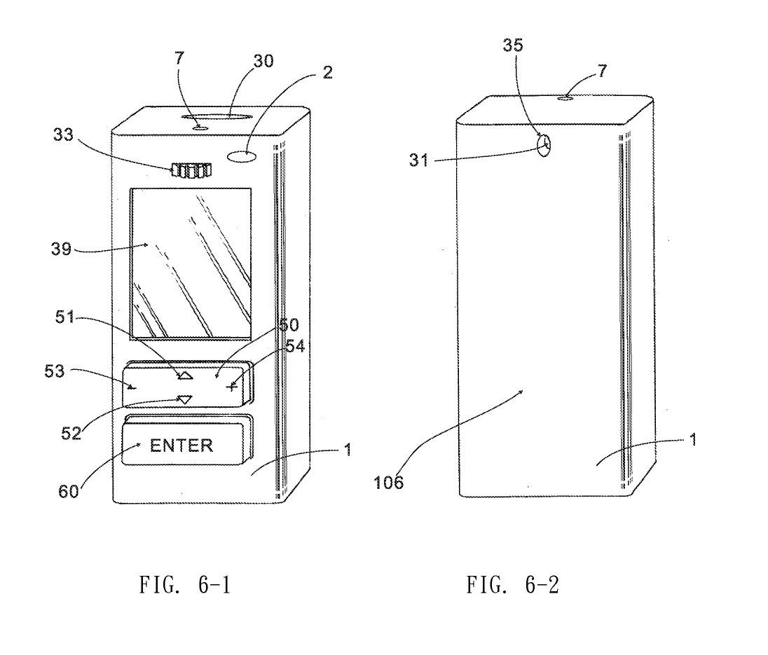

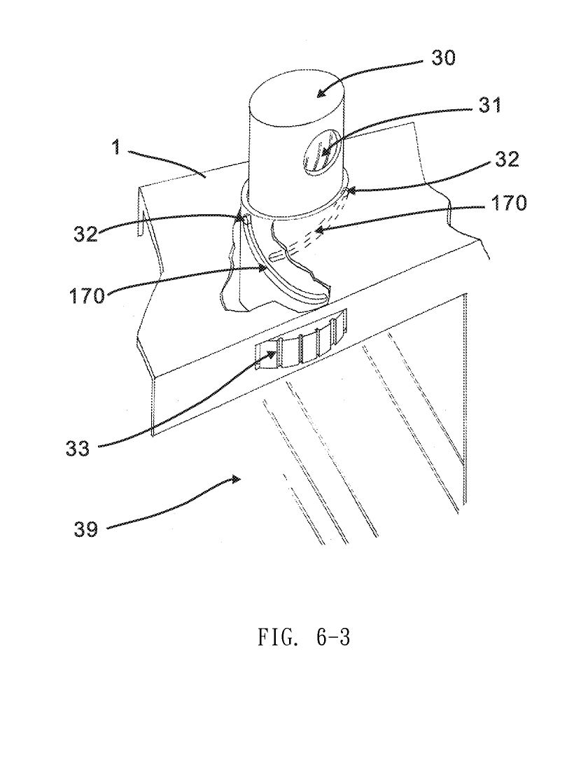

Referring to FIGS. 6-1, 6-2 and 6-3, this example is mainly composed of the remote control body (1), the screen (39) and embedded lens (31). Remote control body (1) has a front face and a top face, a guided-positioning structure at the top face as mentioned above. In this example, by means of the first-guiding structure in sliding locating is guided-positioning combined structure composed of positioning pole (32) and sliding track (170). Additionally, the screen (39) is located in the front face mentioned as above; embedded lens (31) are installed at the top face mentioned as above, and is hidden located by the first guided-positioning structure.

In this example, there is a screen (39) in the remote control body (1) at the top, the embedded lens (31) in one of its drawtube (30) in the back. Mode selection keys (50) is set below the screen (39), and the mode selection keys (50) when pressed right is the increase key (54), pressed left is the reduce key (53), pressed up is the next key (51), pressed down is the back key (52), on the bottom of the mode selection key (50) is the enter key (60). When a magnifying glass is used, firstly select magnifying glass function in the mode selection keys (50), and at the same time press increase key (54) to use its built-in circuit chip's features of zoom in or zoom out, and then through rearview window (35) shoot the scene to enlarge the images by the embedded lens (31), by pressing increase key (54) to make the image enlarged so as to reach the function of a magnifying glass.

The embedded lens (31) in the back of a remote control body (1) is rotated by means of the knob (33) on the remote control body (1) and the embedded lens (31) to both sides of positioning poles (32) slide upward or downward by sliding channel (170), after rotate 180 degrees to the front of the camera positioning, and then press mode selection keys (50) to select the mirror mode, can be through the embedded lens (31) taking images and display on the screen (39), which can function as a mirror, the image can also be enlarged by pressing increase key (54) to zoom in the images and function as a magnifying glass.

### EXAMPLE 7

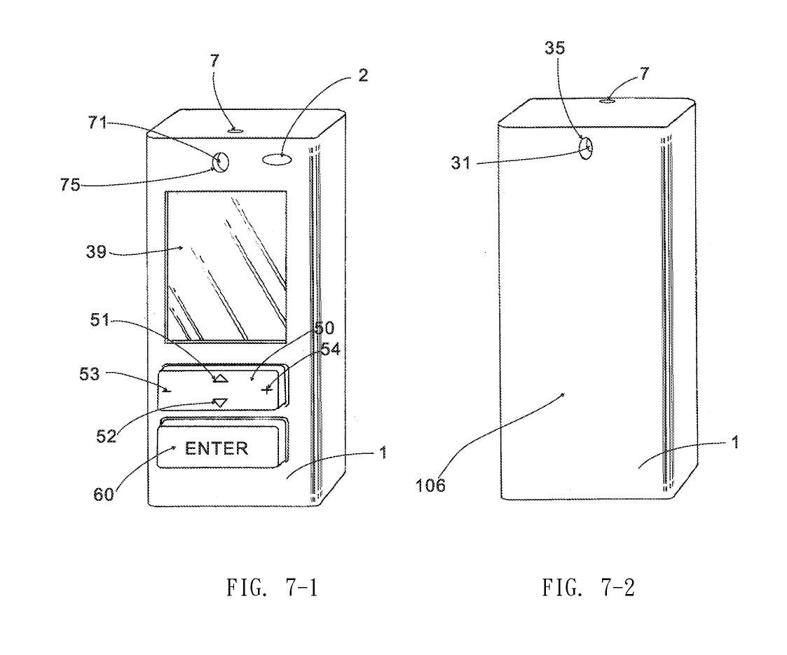

Referring to FIG. 7-1 and FIG. 7-2, this example is mainly composed of the remote control body (1), the screen (39) and embedded lens (31). Remote control body (1) has a front face (105), back face (106), and the established surface. Screen (39) is located in the front face (105) mentioned as above; embedded lens (31) can be set at the established surface, which can be established in the front face (105) mentioned as above, as shown in the FIG. 7-1, and can be also located in the back face (106) as shown in the FIG. 7-2.

Now referring to FIG. 7-1, if embedded lens (31) can be set on the front face (105) of a remote control body (1) used as an example, a front window (75) and a former lens (71) are installed at the top of the front face (105) of a remote control (1). And referred to the structure and operation principle as same as made in example 6, the model selection keys (50) can be used to switch into a mirror mode to be used as a mirror. The function likewise as a magnifying glass is the same way.

Since certain changes may be made in the above described invention without departing from the spirit and scope of as the invention herein involved, it is intended that all of the subject matter of the above description or shown in the accompanying drawings shall be interpreted merely as examples illustrating the inventive concept herein and shall not be construed as limiting the invention.

What is claimed is:

1. A multi-function remote control, comprising:
a first casing including a back shell, a transceiver component installed in the back shell to send and receive remote control signals;
a second casing pivotally connected to the first casing, a storage space is formed between the back shell and the second casing; and
a mirror disposed in the storage space.

2. The multi-function remote control as claimed in claim 1, further comprising a magnifying glass disposed in the second casing.

3. A multi-function remote control comprising:
a remote control body with a mirror finish back shell, a remote control signal transceiver component installed inside the remote control body; and
a magnifying glass pivotally disposed in the remote control body.

4. The multi-function remote control as claimed in claim 3, wherein said magnifying glass can be rotated out.

5. The multi-function remote control as claimed in claim 3, wherein said magnifying glass can be flipped open.

6. A multi-function remote control, comprising:
a remote control body including a first slot and a second slot, the first slot and the second slot respectively have a first-guiding structure and a second-guiding structure;
a magnifying glass is set inside the first slot, and guided by the first-guiding structure; and
a mirror is set inside the second slot, and guided by the second-guiding structure.

7. A multi-function remote control, comprising:
a remote control body including a front face and a top face which has a guiding structure;
a screen is disposed on the front face; and
an embedded lens is disposed on the remote control body.

8. The multi-function remote control as claimed in claim 7, wherein said the embedded lens is disposed on the front face of the remote control body.

9. The multi-function remote control as claimed in claim 7, wherein said the embedded lens is disposed on the back face of the remote control body.
